(19) United States
(12) Patent Application Publication
(10) Pub. No.: US 2020/0122965 A1
(43) Pub. Date: Apr. 23, 2020

(54) SYSTEM FOR PROVIDING ELEVATOR SERVICE

(71) Applicant: OTIS ELEVATOR COMPANY, Farmington, CT (US)

(72) Inventors: Biswaranjan Pattanaik, Nayagarh (IN); Ramesh Lingala, Hyderabad (IN)

(21) Appl. No.: 16/654,413

(22) Filed: Oct. 16, 2019

(30) Foreign Application Priority Data
Oct. 19, 2018 (IN) 201811039636

(51) Int. Cl. B66B 1/46; B66B 3/00

(52) U.S. Cl. CPC B66B 1/468; B66B 3/006; B66B 2201/4653; B66B 2201/4661; B66B 2201/4615

(57) ABSTRACT

Disclosed is an elevator system in a building for transporting a passenger with a mobile device between a plurality of levels including a first level having lobby, the system comprising an elevator including an accessibility implement, and a controller that communicates with the elevator and the mobile device, the controller configured to render a plurality of determinations including: a first determination that the passenger requires service from an elevator with an accessibility implement, a second determination that the elevator includes an accessibility implement and is available to service the passenger, and the controller configured to transmit instructions to the elevator whereby the elevator effects the second determination.

### BACKGROUND

The embodiments herein relate to an elevator system and more specifically to an elevator system that provides elevator service when specific needs are helpful for a passenger.

Physically challenged people need an extended door open and close times at an elevator to enter into it safely. A system that anticipates a need for such a person would be beneficial for such persons and other passengers.

### SUMMARY

Disclosed is an elevator system in a building for transporting a passenger with a mobile device between a plurality of levels including a first level having lobby, the system comprising an elevator comprising an accessibility implement, and a controller that communicates with the elevator and the mobile device, the controller configured to render a plurality of determinations including: a first determination that the passenger requires service from an elevator with an accessibility implement, a second determination that the elevator includes an accessibility implement and is available to service the passenger, and the controller configured to transmit instructions to the elevator whereby the elevator effects the second determination.

In addition to one or more of the above features and elements, or as an alternate, the controller determines that passenger requires service when the mobile device is within a predetermined distance from the first lobby.

In addition to one or more of the above features and elements, or as an alternate, the controller transmits instructions to the mobile device to alert the passenger that the elevator includes an accessibility implement and is assigned to service the passenger.

In addition to one or more of the above features and elements, or as an alternate, the instructions to the mobile device include navigational directions between a current location of the mobile device and the first lobby.

In addition to one or more of the above features and elements, or as an alternate, the instructions to the mobile device include audibly providing the navigational directions between a current location of the mobile device and the first lobby for guiding a passenger with a visual impairment.

In addition to one or more of the above features and elements, or as an alternate, the accessibility implement comprises delayed idling at the first lobby, which includes the controller instructing the elevator to idle at the first lobby for a first period of time that accounts for a navigational distance on the first level between the current location of the mobile device and the first lobby.

In addition to one or more of the above features and elements, or as an alternate, the system receives accelerometer data from the mobile device during the first period of time and thereby tracks a location of the mobile device, and wherein when the accelerometer data indicates the mobile device is diverging from the navigational directions to the first lobby, the elevator is released from effecting the second determination.

In addition to one or more of the above features and elements, or as an alternate, the system at the end of the first period of time, when the elevator fails to detect a presence of the mobile device proximate the first lobby, the elevator is released from effecting the second determination.

In addition to one or more of the above features and elements, or as an alternate, the controller communicates with the elevator over a first network, and the controller communicates with the mobile device over a second network, wherein the system includes a network beacon operationally disposed at the first lobby for operationally effecting communications over the second network.

In addition to one or more of the above features and elements, or as an alternate, the first network is a wide area network and the second network is a personal area network.

Further disclosed is a method of operating an elevator system in a building for transporting a passenger with a mobile device between a plurality of levels including a first level having lobby, the system comprising an elevator comprising an accessibility implement, and a controller that communicates with the elevator and the mobile device, the method comprises: the controller rendering a plurality of determinations including: a first determination that the passenger requires service from an elevator with an accessibility implement, a second determination that the elevator includes an accessibility implement and is available to service the passenger, and the controller transmitting instructions to the elevator whereby the elevator effects the second determination. In addition or as an alternate, the method further includes one or more of the above disclosed features and elements.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates components of a disclosed embodiment; and

FIG. 3 illustrates steps performed by components according to an embodiment.

### DETAILED DESCRIPTION

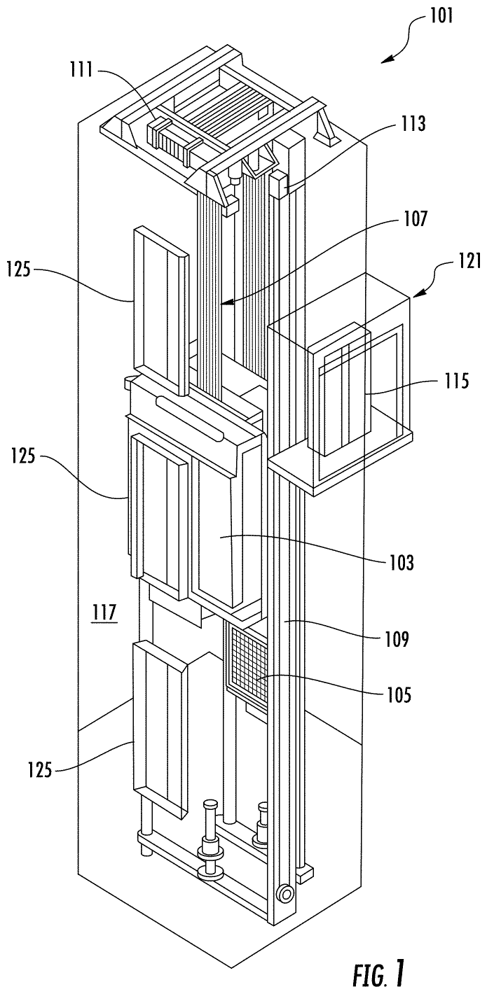

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

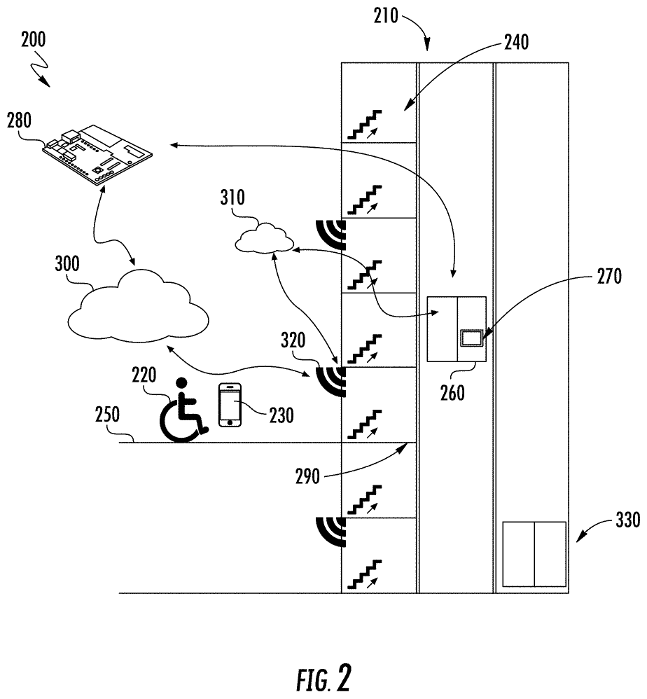

Turning to FIG. 2, disclosed is an elevator system 200 in a building 210 for transporting a passenger 220 with a mobile device 230 between a plurality of levels generally referred to as 240 including a first level 250. The system 200 may comprise an elevator 260 comprising an accessibility implement generally referred to as 270. A discussion of accessibility implements 270 is provided below in this document. The system may include a controller 280 that communicates with the elevator 260 and the mobile device 230.

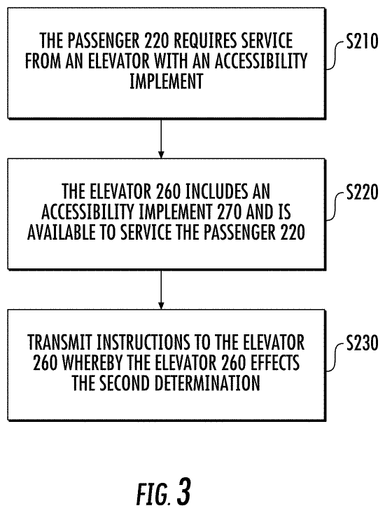

Turning to FIG. 3 the controller 280 may be configured to render a plurality of determinations including: a first determination at step S210 that the passenger 220 requires service from an elevator with an accessibility implement 270 and a second determination at step S220 that the elevator 260 includes an accessibility implement 270 and is available to service the passenger 220. In addition at step S230 the controller 280 may transmit instructions to the elevator 260 whereby the elevator 260 effects the second determination.

According to an embodiment the controller 280 may determine that passenger 220 requires service when the mobile device 230 is within a predetermined distance of a lobby 290 for the elevator 260. For example the passenger 220 may be ten (10) yards from the first lobby 290, which provides sufficient notice to the controller 280 to instruct the elevator 260 to arrive at the first lobby 290. The first controller 280 may transmit instructions to the mobile device 230 to alert the passenger 220 that the elevator 260 includes an accessibility implement 270 and is assigned to service the passenger 220. According to an embodiment the instructions to the mobile device 230 from the controller 280 include navigational directions between a current location of the mobile device 230 and a lobby 290 on the first level 250 for receiving the elevator 260.

According to an embodiment the accessibility implement 270 comprises delayed idling at the first floor 250. Accordingly, the instructions to the elevator 260 include the elevator 260 idling at the first lobby 290 for a first period of time that accounts for a navigational distance on the first level 250 between the current location of the mobile device 230 and the first lobby 290. According to an embodiment the controller 280 may receive accelerometer data from the mobile device 230 during the first period of time and thereby track a location of the mobile device 230. When the accelerometer data indicates the mobile device 230 is diverging from the navigational directions to the first lobby 290, the elevator 260 may be released from effecting the second determination. In addition, at the end of the first period of time, when the elevator 260 fails to detect a presence of the mobile device 230 proximate the first lobby 290, the elevator 260 may be released from effecting the second determination.

In one embodiment the controller 280 may determine that the passenger 280 is visually impaired. In such embodiment, the controller 280 may instruct the mobile device 230 to provide navigational directions as audible instructions. In such embodiment, the controller 280 may identify an elevator 260 that satisfies plural conditions of being equipped with required accessibility implements 270 and being closest to a current location of the passenger. In such embodiment delayed idling by the elevator 260 at the lobby may also be implemented.

Turning back to FIG. 2, the controller 280 may communicate with the elevator 260 over a first network 300, and the controller 280 may communicate with the mobile device 230 over a second network 310. The second network could be, e.g., Bluetooth low Energy (BTLE), short or long range (LoRa) wireless, Wi-Fi, or other known wireless communication network. For the second network 310, the system 200 includes a network beacon 320 operationally disposed at the first lobby 290 for operationally effecting communications over the second network 310. According to an embodiment the first network 300 may be a wide area network and the second network 310 may be a personal area network, such as Bluetooth.

According to the above disclosed embodiments a passenger 220 having a mobile device 230 may be registered in controller 280 for a building 210 which may be a hotel, and provided with key credentials by the controller 280, in order to obtain room access control. The key credentials may indicate that the passenger 220 has a disability, for example, as defined under the Americans with Disabilities Act of 1990 (the ADA). The ADA defines a disability as “a physical or mental impairment that substantially limits one or more major life activities, a person who has a history or record of such an impairment, or a person who is perceived by others as having such an impairment” (https://www.ada.gov/).

In one embodiment once the first mobile device 230 is brought on a first level near a beacon 320 associated with a plurality of elevators generally referred to as 330 including the elevator 260, the controller 280 may communicate with the mobile device 230 over the personal area network (PAN) 310, such as Bluetooth, to obtain the key credentials stored in the mobile device 230 for the passenger 220. The controller 280 may communicate with the mobile device 230 over the personal area network 310, for example over Bluetooth, and obtain the data from the controller 280 that the passenger 220 has the disability.

The controller 280 may effect a determination that an ADA compliant elevator will transfer the passenger 220 to a level selected by the passenger 220. The controller 280 may determine that an elevator 260 in an elevator bank is compliant with the ADA. The controller 280 may transmit instructions for the mobile device 230 to publish an alert indicating a location on the first level 250 for a first lobby 290 associated with the elevator 260. The controller 280 may send instruction to the elevator to travel to a first lobby 290 and idle at the first lobby 290 until instructed to travel to a destination level by the passenger. If the passenger 220 is not detected at the second elevator 260 before a threshold period of time, the controller 280 may release the elevator 260 from effecting the determination.

When sending the instruction the controller 280 may monitor a location of the mobile device 230 of the passenger 220 to thereby track a location of the passenger 220. The controller 280 may monitor the location of the mobile device 230 by receiving accelerometer data from the mobile device 230.

Regarding accessibility implements as identified above, according to an embodiment the ADA accessibility implements for the elevator 260 may be one or more of (i) elevator hall and car buttons that are mounted at certain heights (for example but not limited to 42 inches), (ii) call buttons that are a minimum of for example but not limited to 0.75 inches in diameter, (iii) certain illumination levels for buttons, (iv) braille plates next to buttons and at entrance jambs, (v) two-way communication in elevator cabs that deaf/blind users can utilize, (vi) chimes/verbal announcements that indicate level passing and the next arrival level, (vii) a cab large enough to accommodate a wheelchair and for example but not limited to a 360-degree turn, (viii) hall lantern fixtures that are mounted with their centerlines at least for example but not limited to 72 inches from the level, (ix) door protective/reopening devices that will reopen the door without physical contact, (x) emergency controls that are grouped at the bottom of the elevator control panel and have their centerlines for example but not limited to no less than 35-inches above the finish level, and (xi) handrails at specific heights (for example but not limited to 30 inches). The access implements for an ADA compliant elevator are provided at section 407 of the ADA (executed in 1990 and updated in 2010) and section A17.1-2010, Safety Code for Elevators and Escalators, published by the ASME Handbook (American Society of Mechanical Engineers), each of which is incorporated herein by reference in their entirety.

As used herein, a mobile device which may be referred to as a “smart device” may contain one or more processors capable of communication using with other such devices by applying wired and/or wireless telecommunication protocols. Non-limiting examples of a smart device include a mobile phone, personal data assistant (PDA), tablet, watch, wearable or other processor-based devices. Protocols applied by smart devices may include local area network (LAN) protocols and/or a private area network (PAN) protocols. LAN protocols may apply Wi-Fi technology, which is a technology based on the Section 802.11 standards from the Institute of Electrical and Electronics Engineers, or IEEE. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols may also include Zigbee, a technology based on Section 802.15.4 protocols from the Institute of Electrical and Electronics Engineers (IEEE). More specifically, Zigbee represents a suite of high-level communication protocols used to create personal area networks with small, low-power digital radios for low-power low-bandwidth needs, and is best suited for small scale projects using wireless connections. Wireless protocols may further include short range communication (SRC) protocols, which may be utilized with radio-frequency identification (RFID) technology. RFID may be used for communicating with an integrated chip (IC) on an RFID smartcard. Wireless protocols may further include long range, low powered wide area network (LoRa and LPWAN) protocols that enable low data rate communications to be made over long distances by sensors and actuators for machine-to-machine (M2M) and Internet of Things (IoT) applications.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system in a building for transporting a passenger with a mobile device between a plurality of levels including a first level having lobby,
the system comprising an elevator comprising an accessibility implement, and a controller that communicates with the elevator and the mobile device,
the controller configured to render a plurality of determinations including:
a first determination that the passenger requires service from an elevator with an accessibility implement,
a second determination that the elevator includes an accessibility implement and is available to service the passenger, and
the controller configured to transmit instructions to the elevator whereby the elevator effects the second determination.

2. The system of claim 1 wherein the controller determines that passenger requires service when the mobile device is within a predetermined distance from the first lobby.

3. The system of claim 1 wherein the controller transmits instructions to the mobile device to alert the passenger that the elevator includes an accessibility implement and is assigned to service the passenger.

4. The system of claim 3 wherein the instructions to the mobile device include navigational directions between a current location of the mobile device and the first lobby.

5. The system of claim 4 wherein the instructions to the mobile device include audibly providing the navigational directions between a current location of the mobile device and the first lobby for guiding a passenger with a visual impairment.

6. The system of claim 4 wherein the accessibility implement comprises delayed idling at the first lobby, which includes the controller instructing the elevator to idle at the first lobby for a first period of time that accounts for a navigational distance on the first level between the current location of the mobile device and the first lobby.

7. The system of claim 6 wherein the system receives accelerometer data from the mobile device during the first period of time and thereby tracks a location of the mobile device, and wherein when the accelerometer data indicates the mobile device is diverging from the navigational directions to the first lobby, the elevator is released from effecting the second determination.

8. The system of claim 7 wherein the system at the end of the first period of time, when the elevator fails to detect a presence of the mobile device proximate the first lobby, the elevator is released from effecting the second determination.

9. The system of claim 8 wherein the controller communicates with the elevator over a first network, and the controller communicates with the mobile device over a second network, wherein the system includes a network beacon operationally disposed at the first lobby for operationally effecting communications over the second network.

10. The system of claim 8 wherein the first network is a wide area network and the second network is a personal area network.

11. A method of operating an elevator system in a building for transporting a passenger with a mobile device between a plurality of levels including a first level having lobby,
the system comprising an elevator comprising an accessibility implement, and a controller that communicates with the elevator and the mobile device,
the method comprises:
the controller rendering a plurality of determinations including:
a first determination that the passenger requires service from an elevator with an accessibility implement,
a second determination that the elevator includes an accessibility implement and is available to service the passenger, and
the controller transmitting instructions to the elevator whereby the elevator effects the second determination.

12. The method of claim 11 wherein the controller determines that passenger requires service when the mobile device is within a predetermined distance from the first lobby.

13. The method of claim 11 wherein the controller transmits instructions to the mobile device to alert the passenger that the elevator includes an accessibility implement and is assigned to service the passenger.

14. The method of claim 13 wherein the instructions to the mobile device include navigational directions between a current location of the mobile device and the first lobby.

15. The method of claim 14 wherein the instructions to the mobile device include audibly providing the navigational directions between a current location of the mobile device and the first lobby for guiding a passenger with a visual impairment.

16. The method of claim 14 wherein the accessibility implement comprises delayed idling at the first lobby, which includes the controller instructing the elevator to idle at the first lobby for a first period of time that accounts for a navigational distance on the first level between the current location of the mobile device and the first lobby.

17. The method of claim 16 wherein the system receives accelerometer data from the mobile device during the first period of time and thereby tracks a location of the mobile device, and wherein when the accelerometer data indicates the mobile device is diverging from the navigational directions to the first lobby, the elevator is released from effecting the second determination.

18. The method of claim 17 wherein the system at the end of the first period of time, when the elevator fails to detect a presence of the mobile device proximate the first lobby, the elevator is released from effecting the second determination.

19. The method of claim 18 wherein the controller communicates with the elevator over a first network, and the controller communicates with the mobile device over a second network, wherein the system includes a network beacon operationally disposed at the first lobby for operationally effecting communications over the second network.

20. The method of claim 19 wherein the first network is a wide area network and the second network is a personal area network.
